(19) United States
(12) Patent Application Publication
(10) Pub. No.: US 2025/0348084 A1
(43) Pub. Date: Nov. 13, 2025

(54) SYSTEM AND METHOD FOR GENERATING COMPLEX RUNTIME PATH NETWORKS FROM INCOMPLETE DEMONSTRATION OF TRAINED ACTIVITIES

(71) Applicant: Seegrid Corporation, Pittsburgh, PA (US)

(72) Inventors: Nicholas Alan Melchior, Pittsburgh, PA (US); Benjamin George Schmidt, Wexford, PA (US); Andrew Dempsey Tracy, Pittsburgh, PA (US); Livia Phillips, Pittsburgh, PA (US); Iva Jestrovic, Pittsburgh, PA (US)

(21) Appl. No.: 18/862,690

(22) PCT Filed: Jun. 1, 2023
(86) PCT No.: PCT/US2023/024114

§ 371 Date: Nov. 4, 2024

Related U.S. Application Data
(60) Provisional application No. 63/348,520, filed on Jun. 3, 2022.

(51) Int. Cl. G05D 1/646; G05D 1/617; G05D 1/648; G05D 1/667; G05D 101/10; G05D 107/70

(52) U.S. Cl. CPC G05D 1/646; G05D 1/617; G05D 1/648; G05D 1/667; G05D 2101/10; G05D 2107/70

(57) ABSTRACT

Provided is a system and method for generating routes for use by a mobile robot. The mobile robot can comprise a navigation system in operative communication with a drive system; one or more sensors configured to collect sensor data, wherein the one or more sensors are configured to collect training data representative of a route or portions of a route as the mobile robot is navigated along the route; a user interface configured to receive user inputs providing route information; and a route generator configured to process the route information and the training data to generate a route network comprising a plurality of route segments. The training data can be generated while the mobile robot is navigated in a first direction and the mobile robot is configured to autonomously navigate in a second direction that is opposite the first direction.

### CROSS REFERENCE TO RELATED APPLICATIONS

This application claims the benefit of priority from U.S. Provisional Patent Appl. 63/348,520, filed on Jun. 3, 2022, entitled System and Method for Generating Complex Runtime Path Networks from Incomplete Demonstration of Trained Activities, the contents of which are incorporated herein by reference.

The present application may be related to International Application No. PCT/US23/23699 filed on May 26, 2023, entitled System and Method for Performing Interactions with Physical Objects Based on Fusion of Multiple Sensors, which claimed the benefit of priority from U.S. Provisional Patent Appl. 63/346,483, filed on May 27, 2022, entitled System and Method for Performing Interactions with Physical Objects Based on Fusion of Multiple Sensors, the contents of which are incorporated herein by reference.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle-Mounted Sensor; International Application No. PCT/U.S. Pat. No. 23,016,589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement/Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure, the contents of which are incorporated herein by reference.

The present application may be related to U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement, U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/410,355 filed on Sep. 27, 2022, entitled Dynamic, Deadlock-Free Hierarchical Spatial Mutexes Based on a Graph Network; and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to US Provisional Appl. 63/324,182 filed on Mar. 28, 2022, entitled A Hybrid, Context-aware Localization System for Ground Vehicles; U.S. Provisional Appl. 63/324,184 filed on Mar. 28, 2022, entitled Safety Field Switching Based On End Effector Conditions; US Provisional Appl. 63/324,185 filed on Mar. 28, 2022, entitled Dense Data Registration From a Vehicle Mounted Sensor Via Existing Actuator; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,188 filed on Mar. 28, 2022, entitled Continuous And Discrete Estimation Of Payload Engagement/Disengagement Sensing; U.S. Provisional Appl. 63/324,190 filed on Mar. 28, 2022, entitled Passively Actuated Sensor Deployment, U.S. Provisional Appl. 63/324,192 filed on Mar. 28, 2022, entitled Automated Identification Of Potential Obstructions In A Targeted Drop Zone; US Provisional Appl. 63/324,193 filed on Mar. 28, 2022, entitled Localization Of Horizontal Infrastructure Using Point Clouds; U.S. Provisional Appl. 63/324,195 filed on Mar. 28, 2022, entitled Navigation Through Fusion of Multiple Localization Mechanisms and Fluid Transition Between Multiple Navigation Methods; U.S. Provisional Appl. 63/324,198 filed on Mar. 28, 2022, entitled Segmentation Of Detected Objects Into Obstructions And Allowed Objects; U.S. Provisional Appl. 63/324,199 filed on Mar. 28, 2022, entitled Validating The Pose Of An AMR That Allows It To Interact With An Object, and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design patent application Ser. No. 29/398,127, filed on Jul. 26, 2011, U.S. Pat. No. D680,142, Issued on Apr. 16, 2013, entitled Multi-Camera Head, U.S. Design patent application Ser. No. 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195, published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to the field of robotic vehicles and automated mobile robot (AMRs). In particular, the inventive concepts may be related to systems and methods in the field of route generation and following, which can be implemented by or in an AMR.

### BACKGROUND

Training by demonstration is an effective way to teach robots to perform tasks, such as navigation, in a predictable manner. Restrictions on training often exist to prevent user error. For example, zones cannot span stations so that users cannot train a network containing paths that enter a zone but never pass through a trained exit. However, this restriction means that when a large area needs to be covered by an intersection, no stations may exist in this area. If branching of the route network is required, the branches must be located outside of the intersection, and redundant training may be necessary.

In example embodiments a system allows people to train route networks by demonstrating them on an Autonomous Mobile Robot (AMR), a form of which is a Video Guided Vehicle (VGV). Typical training involves a user navigating the AMR through an environment to learn routes within a facility layout. Subsequently, in use, the AMR can navigate itself along the learned routes in a manner that mimics its translation during the training exercise. Routes are trained from station to station, with any open intersections closed within the same segment. Actions (picks and drops) with globally-unique names may be placed on a route segment. Training a collection of lanes, with many actions inside an intersection, could require many training sessions covering the same ground.

Routes within the environment can be logically represented as a series of route segments. An AMR may navigate a plurality of route segments to navigate a route that can comprise one or more stops for load pick up and/or drop off. Currently, in creating a network of mobile robot route segments, many route segments must be demonstrated, with significant duplication and precise coordination.

### SUMMARY

In accordance with various aspects of the inventive concepts, provided is a mobile robot, comprising: a navigation system in operative communication with a drive system; one or more sensors configured to collect sensor data, wherein the one or more sensors are configured to collect training data representative of a route or portions of a route as the mobile robot is navigated along the route; a user interface configured to receive user inputs providing route information; and a route generator configured to process the route information and the training data to generate a route network comprising a plurality of route segments.

In various embodiments, the training data is generated while the mobile robot is navigated in a first direction and the mobile robot is configured to autonomously navigate in a second direction that is opposite the first direction.

In various embodiments, the route generator and user interface are configured to cooperatively generate a display of one or more of the route segments.

In various embodiments, the route information includes unnamed nodes used for connecting route segments while generating the route network.

In various embodiments, the route information includes one or more destinations at which the mobile robot is to perform at least one task.

In various embodiments, the at least one task includes a load pick up and/or a load drop off.

In various embodiments, the route generator is configured to generate a lane zone for one or more lanes identified in the route information.

In various embodiments, the route generator is configured to generate a grid zone for one or more intersections identified in the route information, wherein a grid zone does not include a lane or a lane zone.

In accordance with another aspect of the inventive concepts, provided is a route generation method for a mobile robot, comprising: using one or more sensors to collect training data representative of a route or portions of a route as the mobile robot is navigated along the route; providing a user interface to receive user inputs providing route information; and processing the route information and the training data to generate a route network comprising a plurality of route segments.

In various embodiments, the method further comprises generating the training data while the mobile robot is navigated in a first direction and the mobile robot is configured to autonomously navigate in a second direction that is opposite the first direction.

In various embodiments, the method further comprises generating a display for presentation via the user interface device of one or more of the route segments.

In various embodiments, the route information includes unnamed nodes used for connecting route segments as part of generating the route network.

In various embodiments, the route information includes one or more destinations at which the mobile robot is to perform at least one task.

In various embodiments, the at least one task includes a load pick up and/or a load drop off.

In various embodiments, the method further comprises generating a lane zone for one or more lanes identified in the route information.

In various embodiments, the method further comprises generating a grid zone for one or more intersections identified in the route information, wherein a grid zone does not include a lane or a lane zone.

### BRIEF DESCRIPTION OF THE DRAWINGS

The present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of an AMR forklift that can be configured to implement dynamic path adjust, in accordance with aspects of the inventive concepts; and

FIG. 2 is a block diagram of an embodiment of an AMR, in accordance with aspects of the inventive concepts;

FIG. 3 through FIG. 5 illustrate various sensors that may be employed by an AMR in accordance with aspects of inventive concepts;

FIG. 6 and FIG. 7 illustrate various lift components such as may be employed by an AMR in accordance with aspects of inventive concepts;

FIG. 8 depicts a conventional approach to lane-building and lane-depletion;

FIG. 9 depicts an embodiment of possible AMR routes;

FIG. 10 depicts example embodiments of the process of training and building routes within an intersection including lane zones and grid zones;

FIG. 11 depicts the route network elements of FIG. 10;

FIG. 12 depicts a planned route;

FIG. 13 depicts a timeline associated with a planned route;

FIG. 14 depicts a timeline associated with a planned route; and

FIG. 15 depicts a timeline associated with a planned route.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

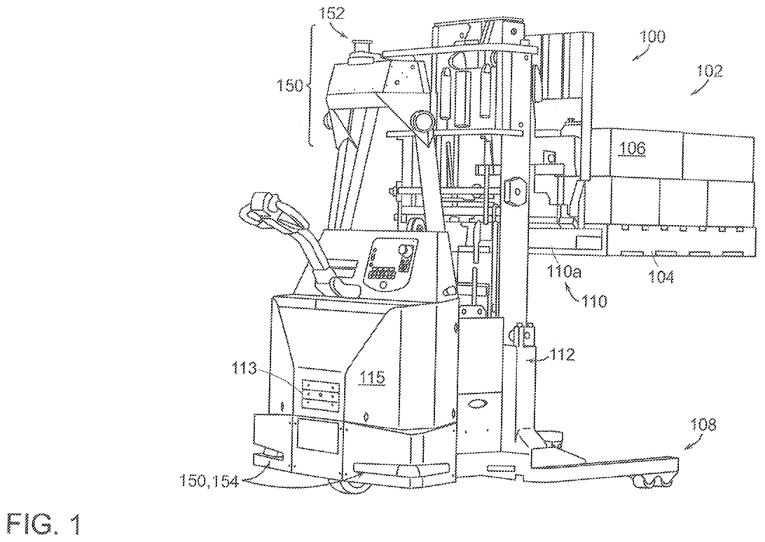

Although inventive concepts may be employed with any of a variety of robotic vehicles, e.g., autonomous mobile robots (AMRs), for brevity and clarity of description example embodiments will be primarily directed herein to AMR fork trucks, an example embodiment of which is illustrated in FIG. 1.

Aspects of the inventive concepts disclosed herein relate to systems and methods for generating links in a directed graph of demonstrated robot travel, using a reduced set of demonstrations (or training runs). The reduction in demonstration does not reduce the safety associated with spatial mutexes or smoothness/reliability of more-complete demonstrations. In some embodiments, one or more of the systems and/or methods described herein comprise “path reversal” functionality, i.e., automatic generation of travel in direction opposite of that trained. In some embodiments, one or more of the systems and/or methods described herein comprise functionality that implements “automatic placement of behaviors.” In some embodiments, one or more of the systems and/or methods described herein comprise functionality that implements automatic generation of unique segments for graph connectivity. In some embodiments, one or more of the systems and/or methods described herein comprise functionality that implements “invisible stations,” i.e., unnamed nodes, in path networks used for connecting generated links. In some embodiments, one or more of the systems and/or methods described herein comprise functionality that implements “segment splicing,” i.e., automatic location of optimal merge points between demonstrated (or trained) segments and the joining of such segments.

In various embodiments, a user interface can be provided to enable the generation of route segments. The user interface (UI) can be presented on the AMR or on a computer that communicates with the AMR, such as a laptop, tablet, phablet, desktop, mobile phone, or other such computer device having a user interface. A “wizard” may be generated at or within the UI to assist a user in inputting information necessary for performing route segmentation, e.g., the wizard user interface can present computer displays that guide a user through selecting routes and route nodes to enable a route generator to generate route segments from such information. The route segments can combined to form a route for the AMR to navigate through an environment to various destination points or zones, e.g., for loading and/or unloading goods. Route segmentation can be performed a priori for the AMR and then, at least in some embodiments, dynamically updated as the AMR navigates its route. Dynamically updating the route can include generating or editing route segments in real-time to accommodate for route or intersection congestion, inability to access a portion of the route (e.g., blocked aisle), change in order of destination, addition or deletion of a destination, and so on. There could be other reasons to dynamically update the route with updated generation of route segments.

In various embodiments, systems and method in accordance with aspects of the inventive concepts can be directed to a route generator that performs an automated build procedure to generate route segments derived from training and inputs from the wizard UI, which can include validating trained behaviors and graphing connectivity between route nodes. In combination with the UI, the system (e.g., the route generator) can represent route segments and AMR behaviors relative to the route segments, including at various destinations and/or intersections, graphically in a display.

In various embodiments, system and method in accordance with aspects of the inventive concepts can be directed to automated creation of a network of mobile robot (or AMR) route segments via demonstration of paths to follow and an indication of behaviors to be performed at precise positions (or ranges of positions) along these routes, which can include loading and/or unloading zones as destinations. In various embodiments, the route network can also contain overlapping segments and portions of segments that require spatial mutexes during execution to protect against simultaneous occupancy by multiple robots.

In conventional training, a large number of route segments must be demonstrated with significant duplication and precise coordination to thoroughly train the mobile robot for reliable autonomous navigation.

Aspects of the inventive concepts relate to systems and methods that drastically reduce the repetitive travel (including all of the difficult forks-first training) and definition of intersections and actions presently required. In some embodiments, a “wizard” training user interface 102 guides the user through training the minimal route segments required for route generation and segmentation. In response to user interaction with the wizard UI 102, a build process generates reversed segments, actions, intersections, and all the segments and stations required to complete the route network for the AMR 100.

Aspects of the inventive concepts disclosed herein relate to systems and methods directed to:
1) Training-by-demonstration of directed path network links between named nodes,
2) Spatial mutexes for protecting travel in some critical sections, and
3) Uniquely-named behaviors located at trained positions on path segments.

In some embodiments, open-source tools are not required. In some embodiments, the system can be implemented on a general-purpose Linux computer, using many open-source packages. Various environments and programming approaches can be used to implement functionality in accordance with the inventive concepts, such as using existing, off-the-shelf, modified or customized, and/or completely original code modules. The inventive concepts are not reliant on use of any particular programming environment or operating system.

In some embodiments, the systems and/or methods described herein can be used for lane staging. In some embodiments, the systems and/or methods described herein can rely on the training-by-demonstration approach enabled by a route building program, e.g., the Seegrid Grid Engine™.

Aspects of the inventive concepts disclosed herein are advantageous and novel over prior approaches. Using system and methods in accordance with the inventive concepts disclosed herein, the amount of duplicate travel training is drastically reduced. Training while traveling in reverse is more difficult to demonstrate, so the inventive approach eliminates the need to train in reverse by using forward motion over the same path. Some of the necessary behaviors are placed on the path (or route) segments automatically, rather than needing to be trained precisely in relation to other behaviors or other path segments. In some embodiments, connectivity of the path network and arrangement of intersections is handled automatically. In some embodiments, nested intersections are also created automatically, which eliminates the need to choose between the increased throughput of fine-grained intersections and the potential for deadlock without intersections.

In some embodiments, aspects of the inventive concepts are configured to work with Seegrid AMRs, such as Seegrid's Palion™ line of AMRs. In some embodiments, aspects of the inventive concepts disclosed herein are configured to work with a warehouse management system (WMS), such as Seegrid Supervisor™, which enables the intersection functionality, which is a desired (but separable) part of the system. In other embodiments, systems and methods in accordance with the inventive concepts can be implemented with other forms of autonomously navigated vehicles and/or mobile robots and warehouse management systems.

Aspects of the inventive concepts disclosed herein simplify training of a complex application with many overlapping route segments. Although trivial lane staging applications can be created without it, this invention makes it feasible to train larger instances efficiently.

Aspects of the inventive concepts disclosed herein may augment a pre-existing route network, constructed by operators through training-by-demonstration. In various embodiments, the existing system provides some features and constraints:
1) The route network may be modeled as a graph with named stations as the nodes, and trained segments are represented as the edges. Various behaviors (point behaviors such as picks/drops and zone behaviors such as intersections) may be trained within the segments.
   a) Trained segments may include any combination of forward and reverse travel, but they may only be followed in the demonstrated direction(s).
   b) Multiple segments may start and end at each station.
   c) Autonomous follows may be started and ended at stations.
   d) Zone behaviors do not span stations.
   e) Some zones (intersections in particular) cannot be nested or overlapping.
2) A build procedure converts information gathered during training (odometry and user input for behaviors) into the route network suitable for autonomous follows.
3) When following a requested route through the graph, the AMR executes behaviors as they are encountered.

In prior approaches, restrictions on training can exist to prevent user error. For example, zones cannot span stations so that users cannot train a network containing paths that enter a zone but never pass through a trained exit. However, this restriction means that when a large area needs to be covered by an intersection, no stations may exist in this area. If branching of the route network is required, the branches must be located outside of the intersection, and redundant training may be necessary.

Aspects of the inventive concepts disclosed herein provide a training and building procedure that addresses both problems. The training procedure still prevents training problematic graphs, but greatly reduces redundant travel. In some embodiments, it is specifically designed for the path segments required for “Lane Staging,” an application in which a “travel aisle” abuts a collection of “lanes.” The lanes are perpendicular to the aisle and contain regions in which an action (pick/drop) may occur. The AMR will typically enter the staging area via the aisle, reverse into a lane, perform the action, and then move forward to exit the lane. It may visit additional lanes in the same manner prior to eventually leaving the area via the aisle.

Aspects of the inventive concepts disclosed herein relate to a system for training an autonomous mobile robot (AMR) in a manner that may reduce the time and travel required to train the AMR. Inventive concepts may be employed in a variety of AMR applications, but their advantages may be best illustrated in the context of lane building and depletion. As a result, for clarity and brevity of description, illustrated embodiments will focus on lane building and depletion, although inventive concepts are not limited thereto. In some embodiments the autonomous guided vehicle may be a visually guided vehicle (VGV) and the descriptions that follow may, for brevity and clarity of description, focus on such vehicles.

The operations of lane-building and lane-depletion, which may be referred to herein as lane staging, typically take place in a warehouse. Lanes are staging areas for pallets and are typically part of warehouse workflows at docks. Inbound pallets are arranged in rows (lanes) when they are ready to be put away within the facility. This may follow some pre-processing steps such as receiving and re-palletization. Outbound pallets are collected from (potentially many) locations within the warehouse and staged in rows (lanes) for loading on a truck. AMRs in accordance with principles of inventive concepts may be employed to deplete inbound lanes (that is, remove the inbound pallets from the lanes and store them within the facility) and build outbound lanes (that is, collect pallets from within the warehouse and stage them in lanes for loading.

In example embodiments a route network may be constructed by an operator through training-by-demonstration, wherein an operator leads the AMR through a training route and inputs behaviors (for example, picks or places) along the route. A build procedure employs information gathered during training (for example, odometry, grid information including localization information, and operator input regarding behaviors) into a route network. The route network may then be employed by an AMR to autonomously follow during normal operation. The route network may be modeled, or viewed, as a graph of nodes and edges, with named stations (invisible stations are discussed below) as nodes and trained segments as edges. Behaviors may be trained within segments. Behaviors may include “point behaviors” such as picks and drops or “zone behaviors” such as intersections. In example embodiments an AMR's repetition during normal operations of a trained route may be referred to as a “follow.” Anything, other than the follow itself, the AMR does during the follow may be viewed as a behavior. Zones such as intersections may include behaviors that are performed before, during, and/or after the zone. For intersections, the AMR requests access to the intersection from a supervisory system (for example, Supervisor™ described elsewhere herein) prior to reaching the area covered by the intersection zone. When the AMR exits the zone, it releases that access to the supervisory system. These instances of coordination and communications with the supervisory system are behaviors. //Trained segments may include any combination of forward and reverse travel. A plurality of segments may start and end at each station. Autonomous follows (that is, the autonomous following of a segment by an AMR) start and end at stations. Some zones (intersection zones, for example) cannot be nested or overlapping. Zone behaviors cannot span stations. This restriction on training eliminates the possibility of user error. In example embodiments AMR trainers demonstrate each segment separately and the segments can be combined in a representation such as a graph. If intersection zones could span stations, the trainer would train the intersection entrance in one segment (for example, from station A to station B) and exit in another (for example, B to C). Other segments may be trained that start and end at the same stations. This would create the possibility of forgetting to match up entrances and exits during training or following. For example, the user could train B to D without the intersection exit. In that case, if the AMR follows A to B to D, it would never release access to that intersection. When following a route an AMR executes behaviors as it encounters them along the route according to behaviors input by an operator during training.

In example embodiments a system and method in accordance with principles of inventive concepts may employ a training and building process that features one or more of the following elements: the automatic generation of a path in the opposite direction from that traveled during training; the automatic placement of behaviors; the automatic generation of unique segments for graph/route connectivity; unnamed nodes, referred to as “invisible stations” in a path network that may be used to connect generated links; and the automatic location of an optimal merge point between demonstrated segments (also referred to herein as trained segments), referred to herein as “segment splicing.”

In example embodiments robotic vehicle may include a user interface, such as a graphical user interface, which may also include audio or haptic input/output capability, that may allow feedback to be given to a human-trainer while registering a piece of industrial infrastructure (such as a pallet) to a particular location in the facility using a Graphical Operator Interface integral to the AMR. The interface may include a visual representation and associated text. In alternative embodiments, the feedback device may include a visual representation without text.

In some embodiments, the systems and methods described herein rely on the Grid Engine for spatial registration of the descriptors to the facility map. Some embodiments of the system may exploit features of “A Hybrid, Context-Aware Localization System for Ground Vehicles” which builds on top of the Grid Engine, Application No. PCT/US23/016556. Some embodiments may leverage a Grid Engine localization system, such as that provided by Seegrid Corporation of Pittsburgh, PA described in U.S. Pat. Nos. 7,446,766 and 8,427,472, which are incorporated by reference in their entireties.

In some embodiments, an AMR may interface with industrial infrastructure to pick and drop pallets. In order for an AMR to accomplish this, its perception and manipulation systems in accordance with principles of inventive concepts may maintain a model for what a pallet is, as well as models for all the types of infrastructure for which it will place the pallet (e.g., tables, carts, racks, conveyors, etc.). These models are software components that are parameterized in a way to influence the algorithmic logic of the computation.

Referring to FIG. 1, shown is an example of a robotic vehicle 100 in the form of an AMR that can be configured with the sensing, processing, and memory devices and subsystems necessary and/or useful for lane building or depletion in accordance with aspects of the inventive concepts. The robotic vehicle 100 takes the form of an AMR pallet lift, but the inventive concepts could be embodied in any of a variety of other types of robotic vehicles and AMRs, including, but not limited to, pallet trucks, tuggers, and the like.

In this embodiment, the robotic vehicle 100 includes a payload area 102 configured to transport a pallet 104 loaded with goods 106. To engage and carry the pallet 104, the robotic vehicle may include a pair of forks 110, including a first and second fork 10a,b. Outriggers 108 extend from the robotic vehicle in the direction of the forks to stabilize the vehicle, particularly when carrying the palletized load 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path adaptation, including avoidance of detected objects, obstructions, hazards, humans, other robotic vehicles, and/or congestion during navigation. The sensors 150 can include one or more cameras, stereo cameras 152, radars, and/or laser imaging, detection, and ranging (LiDAR) scanners 154. One or more of the sensors 150 can form part of a 2D or 3D high-resolution imaging system.

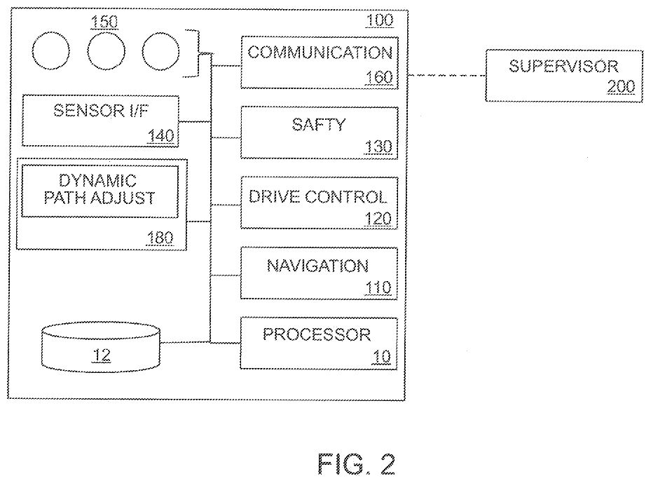

FIG. 2 is a block diagram of components of an embodiment of the robotic vehicle 100 of FIG. 1, incorporating lane building and depletion technology in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “Supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with the supervisor 200 and any other external systems over any now known or hereafter developed communication technology, such as various types of wireless technology including, but not limited to, Wi-Fi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. The supervisor 200 can also monitor the robotic vehicle 100, such as to determine robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, through a machine-learning process, learns and stores the path for use in task performance and builds and/or updates an electronic map of the environment as it navigates. The path may be stored for future use and may be updated, for example, to include more, less, or different locations, or to otherwise revise the path and/or path segments, as examples.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as the electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 110 configured to access environmental data, such as the electronic map, and path information stored in memory 12, as examples. The navigation module 110 can communicate instructions to a drive control subsystem 120 to cause the robotic vehicle 100 to navigate its path within the environment. During vehicle travel, the navigation module 110 may receive information from one or more sensors 150, via a sensor interface (I/F) 140, to control and adjust the navigation of the robotic vehicle. For example, the sensors 150 may provide sensor data to the navigation module 110 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

The sensors 150 can include one or more stereo cameras 152 and/or other volumetric sensors, sonar sensors, and/or LiDAR scanners or sensors 154, as examples. Inventive concepts are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

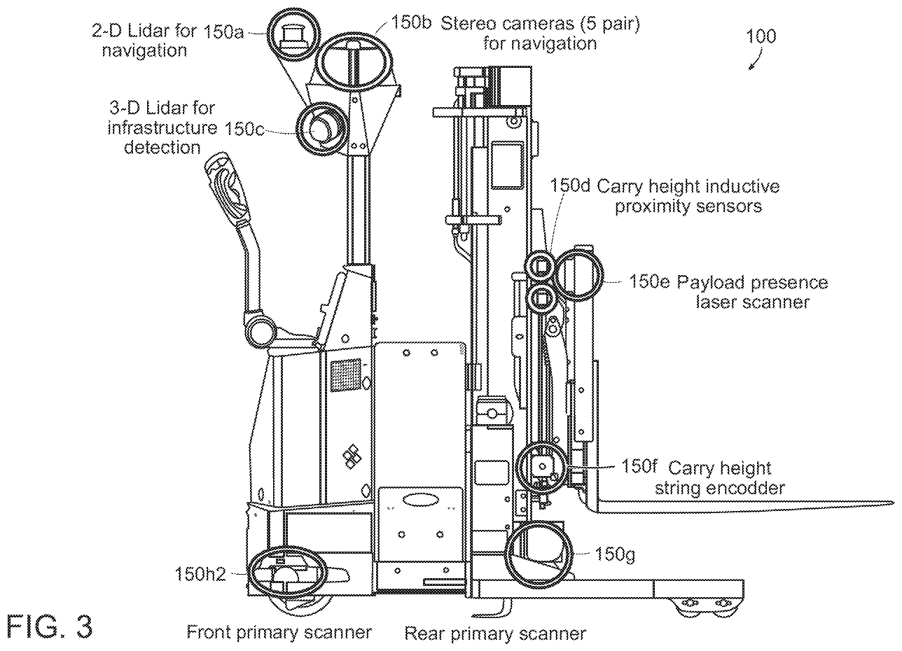

The robotic vehicle 100 (also referred to herein as AMR 100) of FIG. 3 provides a more detailed illustration of an example distribution of a sensor array such as may be employed by a lift truck embodiment of an AMR in accordance with principles of inventive concepts. In this example embodiment sensors include: a two-dimensional LiDAR 150a for navigation; stereo cameras 150b for navigation; three-dimensional LiDAR 150c for infrastructure detection; carry-height sensors 150d (inductive proximity sensors in example embodiments); payload/goods presence sensor 150e (laser scanner in example embodiments); carry height string encoder 150f; rear primary scanner 150g; and front primary scanner 150h.

Any sensor that can indicate presence/absence or measurement may be used to implement carry-height sensors 150d; in example embodiments they are attached to the mast and move with the lift, or inner mast. In example embodiments the sensors may be configured to indicate one of three positions: below carry height (both sensors on), at carry height (one on, one off), above carry height (both sensors off). The carry height string encoder 150f reports the height of the mast to safety module 130. Any of a variety of encoders or position sensing devices may be employed for this task in accordance with principles of inventive concepts. The carry height string encoder 150f may also be used in addition to or in place of the carry height inductive proximity sensors to adjust safety fields in accordance with principles of inventive concepts.

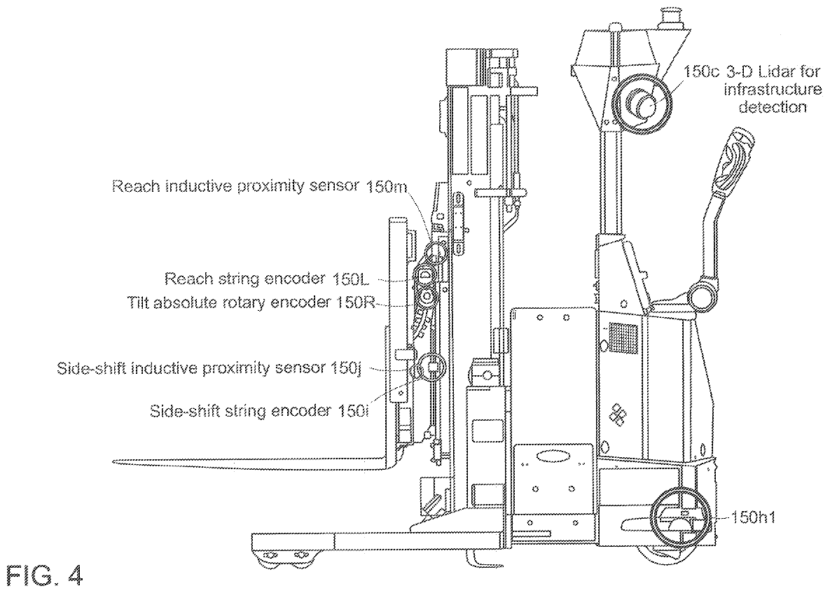

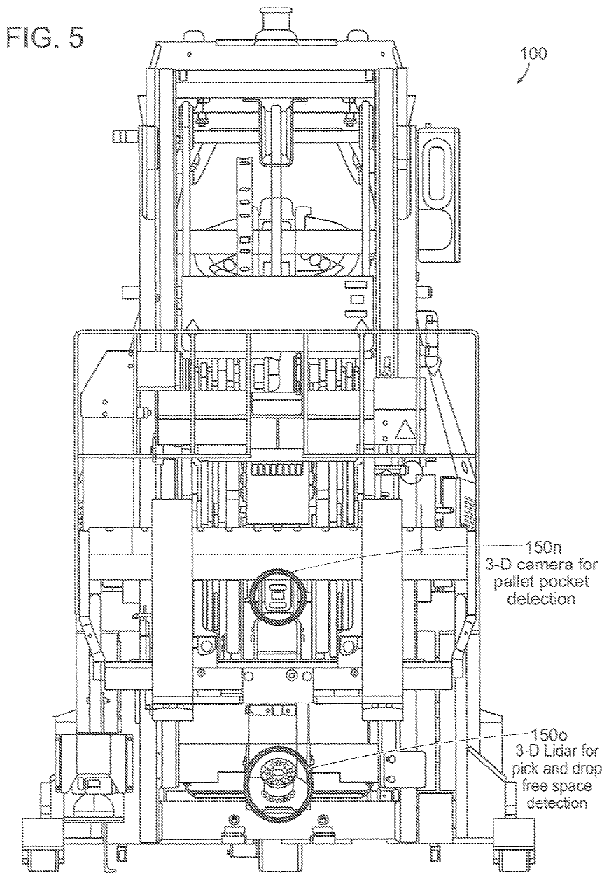

Additional scanners such may be employed by AMR 100 in accordance with principles of inventive concepts are shown in FIG. 4, where the sensors include: side shift string encoder 150i; side shift inductive proximity sensor 150j; tilt absolute rotary encoder 150k; reach string encoder 150l; and reach inductive proximity sensor 150m. Additionally, FIG. 5 illustrates an example embodiment of a robotic vehicle 100 that includes a three-dimensional camera 150n for pallet-pocket detection; and a three-dimensional LiDAR 1500 for pick and drop free-space detection.

Any of a variety of sensors that may indicate presence/absence may be used to determine reach and, in example embodiments, an AMR employs an inductive proximity sensor 150m. In example embodiments, this sensor indicates whether or not the pantograph is fully retracted. In example embodiments a metal flag moves with the pantograph and when the metal flag trips the sensor, the reach is considered to be fully retracted. Reach string encoder 150l may be employed to indicate the position of the pantograph and may be used in place of or in conjunction with the reach proximity sensor 150m.

Although a variety of sensors that indicate presence or absences may be employed, in example embodiments side shift may be indicated by the side-shift inductive proximity sensor 150j. In example embodiments this sensor indicates whether the pantograph is centered left-to-right when viewing the AMR from the rear. In example embodiments a metal flag shifts with the pantograph and when this flag trips the senor, the pantograph is considered centered.

In example embodiments an AMR may employ an inductive proximity sensor and encoder 150k to perform the tilt detection function of the pantograph. The tilt detection reports the pitch of the forks from front to back and may be employed by safety module 130 to adjust/control safety fields, for example. In example embodiments the sensors may provide binary results, such as presence or absence, which the safety module 130 may employ to establish a binary output, such as an expanded or compressed safety field. In example embodiments the sensors may provide graduated results, such as presence at a distance, which the safety module may employ to establish a graduated output, such as a variety of expansions or compressions of safety fields.

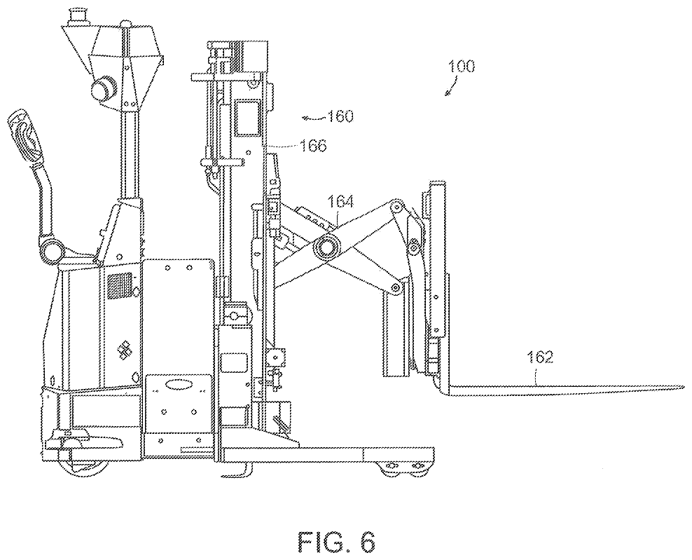

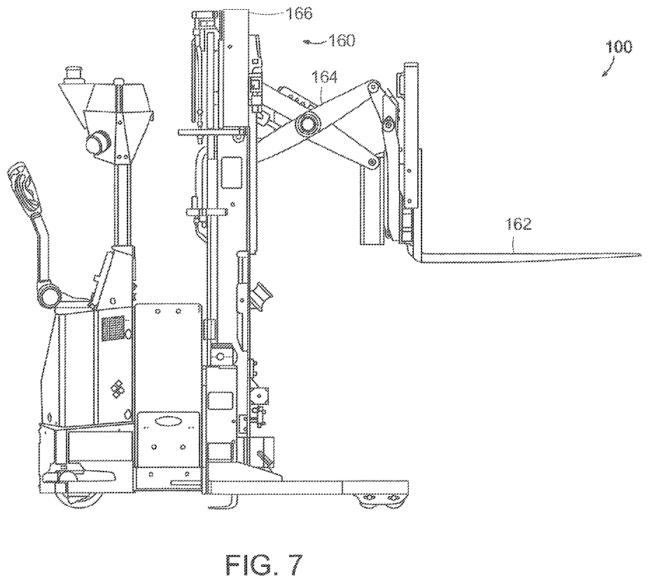

Turning now to FIG. 6, in example embodiments an AMR 100 may include components, which may be referred to herein collectively as mast 160, that includes forks 162, pantograph 164 and a vertical lifting assembly 166. Vertical lifting assembly 166 may include a lift cylinder, a tilt cylinder, a chain wheel, a chain, inner and outer masts, and a lift bracket, for example. Pantograph 164 may be extended or retracted to correspondingly extend or retract the “reach” of forks 162 away or toward the main body of the AMR. In the example of FIG. 6, lift assembly 166 has raised forks 162 to a travel height (a height suited for nominal vehicular travel within its given environment) and pantograph 164 has been extended to extend the reach of forks 162 away from the main body of robotic vehicle 100. A configuration such as this may be assumed by a vehicle 100 during the process of picking or placing a load, for example. FIG. 7 shows AMR 100 with forks 162 raised by lifting assembly 166 and extended by pantograph 164.

In example embodiments a system and method in accordance with principles of inventive concepts may train an AMR to carry out a manipulation operation, for example, within a facility within which the AMR is to interact with an infrastructure element. The infrastructure element may be fixed, quasi-fixed, or mobile, for example. One or more elements may be manipulated by the AMR and may be manipulated in relation to another element. For example, an AMR may be trained to pick (or place) a pallet from (to) lane. To train an AMR to pick up a pallet from a lane an operator may place the AMR in training mode, interact with the AMR to identify the task it is about to learn, and then begin to walk the AMR through the facility. As the AMR is led through the facility, it employs its localization system to determine its location within the facility. An AMR in accordance with principles of inventive concepts may employ a localization system using grid mapping. The AMR may also employ simultaneous localization and mapping (SLAM). As the trainer walks the AMR through the facility to prescribed locations the trainer employs a user interface on the AMR to instruct the AMR to manipulate the environment in the manner it is to execute at that location.

In an example of a warehouse embodiment, an AMR may be led to a prescribed interaction site where a trainer walks the AMR, or trains the AMR, through the prescribed manipulation. The AMR uses its localization system to register the prescribed site within the warehouse. The trainer may, additionally, walk the AMR through the prescribed manipulation operation, using an AMR interface to indicate to the AMR what manipulations it is to be performed and with what infrastructure objects. For example, if the AMR is to pick a payload from a lane at location X, the trainer may walk/lead the AMR to location X and step the AMR through a pick operation there. The trainer may employ a combination of training (for example, raising forks, extending forks, etc.) and interaction through a user interface at the interaction site. The trainer may enter parameters or parameter ranges (lengths, widths, heights, shapes, for example) for the AMR to expect when actually executing the operation, after it is trained. When executing the operation the AMR may call up a parameterized object model to use in recognizing an object with which it is to interact. In example embodiments, the object's model and associated descriptor set may be used by the AMR's perception stack to allow the AMR to recognize the object and to interact with it. In example embodiments the object model (as defined by a set of parameters or descriptors) may be employed by the AMR as a prior probability distribution, also referred to as a “prior.” More precisely, the object model's parameters may be employed as an informative prior in a Bayesian probability process, allowing the AMR, through its perception stack, to recognize an object with which it is to interact. After training, the AMR is capable of repeating the operation for which it was trained, using its localization process to navigate the workplace and track where it is within that workspace and repeating its trained pose (the configuration and orientation of its manipulation mechanism, for example). In particular, the AMR may keep track of its localization and pose of its manipulation mechanism, which, in example embodiments may be a fork and mast combination. Elements of the forks' configuration may include: fork height, fork centering, tilt, and reach, for example. Descriptors, or parameters, of infrastructure objects may include: a range of widths, a range of heights, a range of opening heights, stringer, or block for pallet types; or planar surface, rectangularity, a range of valid lengths, a range of valid widths and nominal surface height for a table, for example.

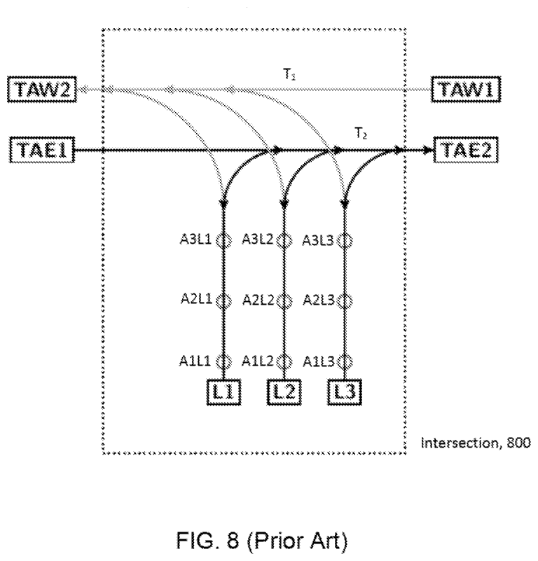

Lane staging (that is, lane-building and lane-depletion) will now be discussed in relation to FIG. 8, which depicts a conventional approach to lane-building and lane-depletion. Conventionally, lane staging may be trained using a combination of picks, drops, intersections, and parallel routes. However, the process can be tedious and repetitive, with the number of repetitions possibly becoming exponentially large as the number of lanes and actions (picks and drops) grows, thereby consuming a great deal of operator time and possibly leading to operator error.

In the example embodiment of FIG. 8 a dock may have an area including an intersection 800 that encompasses three lanes: L1, L2, and L3; and two travel aisles: T1, T2 that are perpendicular to lanes L1, L2, and L3. Travel aisle T1 accommodates “westward,” that is, right-to-left travel and travel aisle T2 accommodates “eastward” or left to right travel. In this example travel flows from travel aisle station TAE1 into intersection 800 eastward and out of intersection 800 to travel aisle station TAE2 along travel aisle T2 and from travel aisle station TAW1 into intersection 800 westward and out of intersection 800 travel to aisle station TAW2.

To enter a lane, an AMR drives past the lane, then reverses into it (so that forks are positioned in the right direction). The AMR must be inside an intersection zone prior to reversing and no stations may be located within an intersection zone (intersection zones are set aside for multi-directional travel). AMRs are trained in segments from one station to another (they are not left “stranded” away from a station) and stations are not allowed within an intersection zone, therefore each station-to-station training segment begins at a station outside the intersection zone 800, enters training zone 800, reverses to an action location (A1L1, A2L1, A3L1 . . . . A3L3) includes an action (e.g., pick or place) at the respective action location, returns to forward motion, exits the intersection zone 800, and ends at another station (starting at station TAW1, traveling aisleTl and ending at station TAW2 or starting at station TAE1 traveling aisle T2 and ending at station TAE2). The total number of segments that must be trained, then, is the product of: the number of start stations, the number of action types (pick or place), the number of action locations, and the number of end stations.

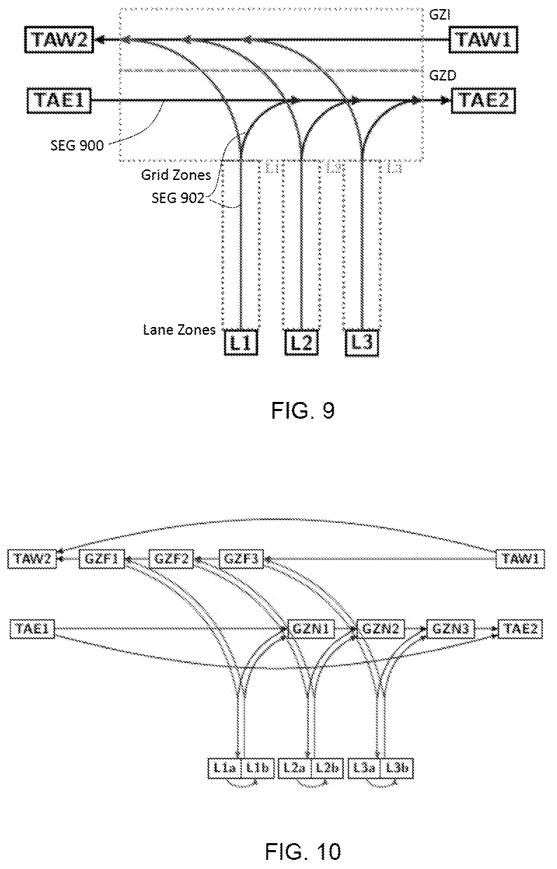

Turning now to FIG. 9, FIG. 9 shows a top view of an embodiment of possible AMR routes, in accordance with aspects of the inventive concepts. FIG. 9 only requires 8 segment types (travel aisles+lanes×travel aisles). The goal of the “Lane Building” is to add capabilities and user interfaces 102 to improve the training and execution of lane building/depletion activities. Specifically, to:
1) Support picks and drops within a linear region (lane) with uncertain positioning.
2) Reduce the tedious, redundant steps that make training time-consuming and error-prone.
3) Improve the use of intersections to make them less error-prone, and to support better throughput in areas of dense reverse motion.

The diagram in FIG. 9 will be used to explain proposed implementations of the required improvements.

In FIG. 9, the user would only need to train the travel aisle segments, and segments from the start of each lane (L1, L2, L3) to one of the travel aisles. Rather than a larger, unsegmented intersection being defined, lanes zones and grid zones (GZI, GZD) are defined. The user can accomplish this, at least in part, using the wizard UI 102. The system, e.g., the route generator 108) processes and combines these demonstrations to create the full route network. These diagrams also show finer-grained intersection zones, which permit greater throughput, and are enabled by the route-building procedure.

The Path Reversal element of the route generator 108 uses the observation that the reverse and forward motion in and out of a lane traverses the same space, with the truck in the same orientation. Since forward motion is easier for a trainer to precisely demonstrate, only the forward motion needs to be trained. The reverse motion segment of the route network is automatically generated.

The Invisible Stations element of the route generator 108 addresses the problem of zones spanning stations. Invisible stations are nodes in the route network that cannot be specified by a user as the start or end of a route. Thus, they can appear in the middle of a zone without risking creation of a plan that fails to traverse both the start and end of each zone, as long as the rest of the route network is constrained in such a way as to make that impossible.

The Segment Splicing element of the route generator 108 assists trainers in finding the optimal merge point from a lane segment into a travel aisle. In the realized implementation of the system, the endpoint of trained lane segments is chosen by the trainer (using the wizard UI 102) as the point at which the AMR is well-aligned with the travel aisle. In prior solutions, that same position must be traversed and marked by the trainer when training the travel aisle. This imposes an ordering in which the segments must be trained, and relies on the trainer to reach the same position accurately when training two segments. Segment splicing in accordance with the inventive concepts automates the location of the merge points. With this feature, the trainer would extend lane segments to the end of the travel aisle into which they are merging, as shown in FIG. 9. During the build phase, the route generator 108 would analyze the partially-overlapping segments to find the optimal position at which they intersect. This would become the merge point, and the remaining portion of the lane segment would be discarded. This makes training easier, since the merge point does not need to be reached precisely as the trainer stops motion of the AMR.

In example embodiments a system and method in accordance with principles of inventive concepts may allow an AMR to perform an action, such as a pick or drop, within a lane without having been trained to the precise location of a pallet (or space).

In some embodiments limitations may be placed on lane usage for safety. For example, VGVs may not be allowed within a lane when a human is within the lane. Signals may be used by the system to indicate to VGVs when a human is within a lane and, therefore, the VGV may not enter or to indicate to a human when a VGV is operating within a lane and a human is not to enter the lane.

In some embodiments VGVs will not build and deplete a lane simultaneously.

In some embodiments, when building a lane, a VGV will stop and place, or drop, its pallet upon encountering the first obstacle it encounters within the lane. Given that no human will be within the lane and that no VGV is depleting the lane, it can be assumed that the first obstacle the VGV encounters will be another pallet (or an end-of-lane indicator).

In some embodiments, during lane depletion a VGV may execute a pick when it encounters an obstacle within a lane. Again, assuming that no human or other VGV is operating within the lane, the first obstacle the VGV would encounter would be a pallet or end-of-lane indicator. A load engagement sensor on the VGV may verify successful picking. In some embodiments a pallet detection system may be employed by the VGV to accommodate non-pallet encounters (an end-of-lane indicator, or other obstacle, for example)

In some embodiments the entire route for lane depletion or building may be predetermined; the VGV may be trained to enter a lane depletion/building area with its ultimate destination (picking/depletion) or origin (placing/building) pre-programmed. That is, the VGV may have been instructed to pick an item, a pallet for example, from a specific location within a warehouse and drop it within a specific lane for out-shipment or to pick an item from within a specific lane and drop it at a specific location within the warehouse. In other embodiments VGV may employ scanning to identify a package and to determine where to place it within a lane (lane building) or where to place it within the warehouse (lane depletion).

In some example embodiments a supervisor, as previously described, may be employed to manage an intersection. In particular the supervisor will manage reverse travel and to track the contents of a lane during depletion and to indicate associated destination to VGVs performing the depletion, including follow commands that include drop locations for picks performed during a lane depletion.

In some embodiments VGVs will employ reverse sensing, such as planar laser scanners or vision-based pallet detection systems or fixed-range fork-tip sensors during reverse operations.

In some embodiments a VGV may employ a sensor to determine whether a pallet is properly positioned against the fork backrest. In some embodiments the sensor may be a Boolean sensor.

In some embodiments a VGV may employ a sensor to determine whether a load has been fully disengaged after a drop. In some embodiments the sensor may be a fork-tip range sensor or a vision-based sensor, for example.

The following definitions apply to terminology used to describe example embodiments of a system in accordance with principles of inventive concepts used in the context of lane building or depletion. As previously indicated, inventive concepts are not limited thereto.

An Action Zone is defined as a continuous section of path in which a single instance of either a pick or drop action may be executed during a follow. In example embodiments the zone may be placed at the end of a reverse segment, just prior to a transition to forward motion.

A Lane Zone is defined as an Action Zone used for lanes.

A Lane Segment is defined as a segment trained from a Lane Zone to a Grid Zone, which may also be followed in reverse.

A Grid Zone is defined as a continuous section of path representing single-direction travel-aisle motion near one or more lanes.

A Grid Zone Set is defined as a single Grid Zone or a pair of Grid Zones providing bi-directional travel near the same collection of lanes.

A Lane Grid is defined as the collection of associated Lane and Grid Zones and associated Lane Segments and Travel Aisle segments required for one lane building/depletion application.

Nested Intersections are defined as a collection of intersections that support constraints on their acquisition and may overlap in space, requiring a VGV to hold more than one intersection grant, that is the exclusive right to operate, at a time. Implementation may require simultaneous or reordered acquisition. If multiple intersections need to be held at the same time, the order in which they are acquired is important. If, for example, two VGVs intend to hold the same pair of intersections, but acquire them in reverse order, they may deadlock. That is, each may acquire one of the two intersections and wait to acquire the other intersection, but neither will proceed. Nesting intersections in accordance with principles of inventive concepts prevents such deadlocks.

Lane Lock is defined as a process supporting the use of Nested Intersections for lane building/depletion applications.

An Invisible Station is defined as an automatically-generated station used for planning through a Lane Grid, but not exposed in user interfaces.

Interleaved Lane Actions are defined as a use case for traversing Lane Grids that visits more than one lane, performing one action in each.

Note that a Lane Zone is a specialization of an Action Zone and Lane Lock is a specialization of Nested Intersections. In each of these cases, only the specialization is required for the implementation of lane building and depletion.

### Action Zones.

As previously indicated, in example embodiments a VGV may operate (pick or drop) on the first object of interest (a pallet, for example) or empty spot it encounters. Rather than assigning names and training discrete actions for each notional pallet position a system and method in accordance with principles of inventive concepts may employ an Action zone, a section of path within which either drops or places may be executed at the deepest reachable location.

In example embodiments the name of an Action Zone fulfills the requirements of the name of an action in that the Action Zone name is used as the name of an Action. Although picks and drops are trained in a different way, Actions trained as Action Zones do not have the same name as the other “normal” Actions. An Action Zone may be trained on a reverse segment and end at a cusp. In example embodiments a user interface may include an Action Zone name within the drop or pick field of a custom route screen, treating the zone itself as an action. In example embodiments, if an Action Zone is not empty when a VGV is executing a drop in the zone, the load may be dropped a fixed (configurable) distance from the first detected pallet within the zone. If the zone is full when a VGV is attempting a drop, the VGV may idle until the area is cleared or the route/assignment is aborted.

When executing a pick in an Action Zone, the VGV may detect and engage the earliest pallet encountered. In example embodiments a payload presence sensor may be employed for such detection. If the Action Zone is empty when attempting to execute a pick, the VGV may produce an error signal.

After performing its action (pick or drop) in example embodiments the VGV switches to forward motion, skipping any portion of the path between its current location and the cusp. That is, the geometry of the path that the VGV is following includes travel all the way to the cusp (back of the lane) and then forward out of the lane, since this is the farthest that the VGV might have to travel. However, if the action is performed earlier (e.g. if the lane was full of pallets during a pick, so the VGV was able to pick from the front of the lane), it would not make sense to continue driving backwards down the rest of the lane, which is full of pallets. Instead, the VGV “skips” the rest of the reverse motion and immediately switches to forward motion to exit the lane.

### Lane Zones.

In example embodiments Lane Zones are a special case of Action Zones. In Lane Zones a VGV's obstruction fields may be diminished, particularly on the sides, to allow operation next to adjacent lanes that may contain pallets, which might otherwise be interpreted as obstructions by the VGV. When building a route an intersection will automatically be generated to cover a Lane Zone. In example embodiments an operator specifies an associated Grid Zone when training a Lane Zone. The Grid Zone permits the automatic creation of intersections. In example embodiments a Lane Zone may span segments. Although, in example embodiments, each Lane Zone is trained in a single training session on a single segment, the entrance and exit positions may be adjusted during the build process. Lane zones begin on the generated segment (that is, a segment such as a splice or reverse generated by the system during build) reversing into a lane and ending on the forward segment exiting the lane. In example embodiments the Lane Segment is trained using only forward motion, but the VGV will reverse into the lane first and use forward motion to exit the lane. As a result, the generated reverse segment must be executed first, and the intersection must be held the entire time the VGV is in the lane. This implies that the intersection entrance must be on the generated reverse segment, and the exit is on the forward segment.

In accordance with principles of inventive concepts, by using Action or Lane Zones rather than discrete action locations within a single lane the number of training segments is reduced to the number of lanes. Additionally, by using zones for training the system better accommodates imprecisely-positioned pallets within a lane and can dispatch a VGV to perform the next available action within a lane without specifically targeting a position within the lane.

In example embodiments Lane Zones (denoted by broken lines and labeled L1, L2, and L3 in FIG. 9) are entirely contained within the intersection associated with the Lane Grid and forward and reverse path segments follow the same arc. For example, the geometry of the reverse travel segment SEG902 from the TAE1-to-TAE2 aisle segment SEG900 to L1 is identical to the forward travel from L1 back to the TAE1 to TAE2 travel aisle segment SEG900.

### Modular Training.

In example embodiments, to traverse each segment of a path geometry, a VGV may be trained to follow each of the travel-aisle segments once and to follow a segment from each lane to each exit direction. To construct a path network from these training examples a system in accordance with principles of inventive concepts may train travel-aisle motion with path segments containing Grid Zones that enclose the area where intersections are required for reversing into lanes. This includes the junctions between lane segments such as SEG 902 and travel-aisle segments SEG900 of FIG. 9. These segments may also be used for crossing a lane grid without any lane actions. VGVs may be trained in lane travel with forward motion from the deepest point of the lane to stations in each exit direction from the grid (for example, TAW2 and TAE2). Lane Zones may be trained over the area where continuous actions are required, and the corresponding Grid Zone may also be specified.

In example embodiments training of reversible Lane Segments may employ a workflow specific to these segments in which:
1) The user specifies the Lane Zone in which to begin training and the Grid Zone of the destination.
2) The system will inform the user of the destination station by determining the next station following the specified Grid Zone.
3) The start of the Lane Zone is coincident with the start of training. The user provides input on the VGV's user interface when the end of the zone is reached.
4) Station Verification may be conducted by the user at the completion of training this segment.
5) If the specified Lane Zone has already been trained, the only valid Grid Zone destinations are that from the already-trained segment (i.e. overwrite) or the other Grid Zone in its Grid Zone Set. In example embodiments the system may offer an option to delete any previously-trained segments containing this Lane Zone at this point.

In example embodiments the system may create a full path network from the above training information, using the automatic generation of additional segments using reversals and splits of the trained segments and a fully-generated short segment at the end of each lane as a unique location to store the action associated with it. This process may be referred to herein as modular lane training.

### Segment Reversal.

Because, in example embodiments, reverse travel into an intersection follows the same path as forward motion out of an intersection, a system in accordance with principles of inventive concepts may train a VGV in one direction in one of these segments and automatically generate the segment that follows the path of the segment in the opposite direction. In example embodiments, the segment may be trained in the forward direction, as driving in that direction may be more kinematically stable. For example, a VGV may be trained from the end of a Lane Zone to the end of a segment exiting the lane grid in the direction from L1 to TAE2. In example embodiments that employ a machine-learning and localization system, such the GridEngine™ system previously mentioned, the path geometry and localization information may be stored differently. Even though the forward and reverse path segments cover the same physical space, changes to the data may be employed to support autonomous travel in different directions.

### Segment Splicing.

Conventionally, L1 would not be a station, not least because it lies within an intersection. In implementing the forgoing segment reversal method, the system transitions from forward travel-aisle motion to reverse motion into lane L1. To illustrate the method, consider movement along a route from TAE1 to L1 to TAE2. Using the reversed segment approach just described provides travel from TAE2 to L1. However, rather than having the VGV travel all the way from TAE1 to TAE2 before reversing, in example embodiments the system has the VGV reverse at the point where the reversed L1 to TAE2 path meets the TAE1 to TAE2 path.

In example embodiments, to implement such a reversal a system and method in accordance with principles of inventive concepts trains the VGV, for each lane, a Lane Segment beginning with a Lane Zone and ending with a station that follows an associated Grid Zone, and the corresponding reversed segment, (for example, TAE2 to L1). The system also trains a travel-aisle Grid Zone segment ending at the same station (for example, TAE1 to TAE2). From these segments, the system generates a new segment beginning with travel-aisle motion and transitioning to reverse motion into the lane (for example, TAE1 to L1).

In example embodiments localizations may be used to locate the earliest point at which the two trained segments overlap. This is the point at which the trained lane segment reaches the position and orientation of the travel-aisle segment. In FIG. 9, this is the endpoint (arrowhead) of the arced segments. This point lies within the Grid Zone (for example, Grid Zones GZI and GZD).

In example embodiments an Invisible Station may be created at this point. In this manner, a system and method in accordance with principles of inventive concepts may shorten the segment traveling forward out of the lane (and the corresponding reversed segment) by replacing the endpoint that otherwise would have been formed at the end of the travel-aisle segment with the Invisible Station.

### Grid Zone.

In example embodiments a grid zone allows a system to train a VGV within a zone with a name that is a continuous and substantially-linear section of path adjacent to one or more Lane Zones, or adjacent to another Grid Zone. The zone may be trained large enough to protect all reverse motion occurring between the travel aisles and any associated Lane Zones. Being roughly linear the zone maintains a consistent vehicle orientation throughout the zone. In example embodiments an intersection may automatically be generated to cover a Grid Zone. The system ensures that a secondary Grid Zone, a Grid Zone separated from Lane Zones by another Grid Zone, takes into account a primary Grid Zone for intersection planning. The two types of Grid Zone may be separate entries in a training user interface, for example. Two Grid Zones associated as primary and secondary Grid Zones constitute a Grid Zone set. If a single, primary, Grid Zone is included in a VGV's training, the single Grid Zone forms its own Grid Zone set. No more than two Grid Zones may be associated into a set. The combination of a Grid Zone Set and all associated Lane Zones may be referred to as a Lane Grid.

With the generation of multiple lane segments spliced into travel-aisle segments, the route network will support routes that enter the lane grid from any direction, visit one or more lanes, then exit to any direction. As currently implemented, planning routes through this network requires a station at each node in the graph for deciding between parallel routes. However, the nodes introduced here are all inside of zones, which is not permitted for trained stations. Moreover, the locations of nodes generated by Segment Splicing are not precisely known by the trainer. Therefore, we must generate automatic stations with unique properties

### Invisible Station.

In example embodiments a system in accordance with principles of inventive concepts may employ invisible stations inside Lane Zones and Grid Zones for path planning. Such stations may be automatically generated, for example, at the cusp (back) of each Lane Zone, which is the starting point of training a reversible segment. The presence of these invisible stations allows the reversible segments to be stored in for path segments. They also permit any combination of entry and exit segments for a lane zone. Without them, a segment may need to be generated combining every possible (reverse-motion) segment for entering a lane with every possible (forward-motion) segment for exiting. In example embodiments two stations are generated so that the action (pick/drop) can be placed on a generated segment between them. The action (pick/drop) may be on a separate segment so that it can be shared between two potential reverse segments leading into the lane. With only a single Invisible Station (with the action on a small loop segment) a VGV may not traverse the action when visiting the lane, thus allowing visits to a lane where no action is planned, which would be undesirable. Thus, in example embodiments, two Invisible Stations are generated.

In example embodiments one Invisible Station is generated at the point where each lane segment is spliced into a Grid Zone. These invisible stations allow for Interleaved Lane Actions; without them, the only route out of a Lane Zone would also exit the entire Lane Grid. The correspondence between Lane Zone and each of the Invisible Stations is used to plan routes through Lane and Grid Zones.

### Intersections.

In example embodiments the training of intersection zones may be automated. Using single-direction travel-aisle motion and one large intersection covering the entire area, an intersection can be automatically created coinciding with the Grid Zone and covering all associated Lane Zones. The reduction of redundant training also eliminates the possibility of training inconsistent intersection bounds on parallel or overlapping segments.

In example embodiments travel-aisle traffic may proceed while a VGV is inside a lane. To allow this, a system in accordance with principles of inventive concepts may employ nested, or hierarchical, intersections while avoiding deadlock situations. A system in accordance with principles of inventive concepts may also support two-way traffic on the travel aisle. To maintain efficiency, traffic on the “secondary aisle” segment (that farthest from the lanes) may not be impeded by traffic in and between the “primary aisle” segments and the lanes. The “primality” of the aisles appears to swap roles in the “bypass” scenario, but the terms refer to the dependence between the intersections when accessing the lanes.

In an example single-direction travel-aisle case, consider creating one intersection for the travel-aisle area (coinciding with the Grid Zone) and one intersection for each lane (coinciding with relevant Lane Zone). The sequence of required intersection grants for a vehicle performing a lane operation is as follows:

| Event/Intersection | Aisle | Lane |
|---|---|---|
| Enter travel-aisle | X | |
| Begin reverse motion | X | X |
| Traverse lane | | X |
| Exit lane | X | X |
| Complete travel-aisle travel | X | |

This formulation permits travel-aisle traffic while a VGV is fully inside the lane. Without additional constraints, though, it could lead to deadlock if one VGV enters the travel aisle bound for a particular lane if another VGV is already in that lane. In that case, the system may stop the first VGV outside of the grid zone until the lane is clear.

Consider the case of two-way travel-aisle traffic. If the VGV is traveling along the “primary aisle” segment for both entrance and exit of the lane grid area, the previous table applies. Use of the “secondary aisle” complicates the situation:

| Event/Intersection | Secondary Aisle | Primary Aisle | Lane |
|---|---|---|---|
| Enter travel-aisle | X | | |
| Begin reverse motion | X | X | X |
| Traverse lane | | | X |
| Exit lane | X | X | X |
| Complete travel-aisle travel | X | | |

As in the previous case, other travel-aisle traffic is permitted while a VGV is entirely inside a lane. Again, to avoid deadlock situation, the system keeps the VGVs outside of the Grid Zones until access to the Lane Zones can be secured. In example embodiments this might be addressed by simply ordering intersection requests such that “lane” intersections are acquired prior to “aisle” intersections in cases where both will be needed. To avoid deadlock in the case of Interleaved Lane Actions, the system may induce a total ordering over all intersections in a Lane Grid. Assuming that all VGVs contain the same route network and the set of segments associated with each Lane Grid is disjoint, the ordering can be computed locally by any deterministic algorithm, such as lexicographic sorting. By ordering the intersection requests in this way, the system allows multiple intersection grants to be acquired by VGVs.

Alternately, in example embodiments VGVs may request all required intersections simultaneously. This eliminates the already-unlikely possibility of deadlock by providing more information to the system (Supervisor) granting access. The ability to provide the complete set of simultaneously-required intersections allows greater safety and flexibility. For example, requests could be prioritized based on the task or lanes visited (including lanes that do not appear early in the request order).

### Nested Intersections

In order to allow travel-aisle traffic while VGVs are inside lanes, but avoid deadlock situation with vehicles attempting to enter occupied lanes, a system in accordance with principles of inventive concepts supports requesting and granting multiple intersections at a time. In order to implement this capability, example embodiments may:
1) Allow a VGV to hold multiple intersection grants at the same time from Supervisor.
2) Allow intersections that may be held simultaneously may introduce an ordering constraint upon their acquisition.
3) Allow intersections to be requested in an order different to the order in which the zones are encountered by the VGV in its route. This may result in a VGV stopping to wait at the entrance to one intersection while waiting for a grant to another intersection.
4) Allow intersections to be released in an order different to the acquisition order.

Similar to the relationship between Action Zones and Lane Zones, the Nested Intersection capability is initially formulated as a feature independent of other lane building/depletion requirements. Lane Lock refers to the use of the feature specifically applied to this application.

### Lane Lock.

Applying the generic capability of simultaneous intersections to the lane-building problem employs knowledge of Grid and Lane Zones and Grids, referred to herein as Lane Lock. In example embodiments Lane Lock supports visiting a single lane, or multiple lanes (for Interleaved Lane Actions) during the traversal of a Lane Grid. In example embodiments:
1) Any requested route begins and ends at stations outside of the Grid and Lane Zones.
2) Any requested route does not revisit a Lane Grid a second time after leaving it.
3) Prior to entering a Grid Zone, the VGV acquires and hold grants for the following set of intersections simultaneously:
4) all Lane Zones visited prior to exiting the last Grid Zone in this Lane Grid (Note: If Interleaved Lane Actions are required, this means that all lanes' intersections are acquired in order to enter the Lane Grid)
5) all Grid Zones visited prior to the next Lane Zone (Note: One or two aisle intersections will be required, depending on the direction of travel-aisle motion).
6) Upon entering a Lane Zone all Grid Zone intersections are released. That is, when the vehicle is fully within the Lane Zone, other travel-aisle traffic may proceed past the lane.
7) Upon exiting a segment containing a Lane Zone that is not revisited during this route, the intersection for that lane is released.
8) The required Grid Zone intersection grant(s) are (re) acquired prior to releasing a Lane Zone grant when exiting a lane.

### Pallet Sensing.

Pallet sensing options may be categorized as requiring or not requiring lateral sensing on the VGV. In example embodiments in which sensors are only required to determine how far into a lane a VGV must travel before executing its action (no lateral sensing), rather that also adjusting its path from side to side (includes lateral sensing), sensing is simpler.

In example embodiments one-dimensional sensing is sufficient for lane building. The VGV will reverse into a lane and stop some distance from the first detected pallet (or the end of the Action Zone if no pallet is detected), then execute its drop. For lane depletion, in example embodiments a VGV may include:

Reverse range detection whereby the distance to obstacles (including pallets) while traveling in reverse is detected and employed to guide the VGV during depletion.

### Load Engagement/Disengagement Sensing.

In example embodiments sensors, which may be Boolean, report when a picked pallet is fully engaged on the forks and a dropped pallet has completely cleared the forks. The engagement sensor is useful for simplifying the logic of performing picks in a lane, while the disengagement sensor improves the robustness and error detection of drops.

### Pallet Detection.

Pallet and/or pocket detection (that is, pallet-pocket detection) may be employed in example embodiments to improve the robustness and efficiency of operation in a lane by providing the ability to distinguish between loads and other obstacles. A vision-based solution with a sensor in the backrest support picks but not drops. This is sufficient since the drop case is generally simpler. In example embodiments a vision-based solution may also support servoing off-path to engage with an imprecisely-positioned pallet. In example embodiments use of planar range sensing in the fork tips may be used in substitution or to supplement vision-based sensing.

### Reverse Range Sensor.

In example embodiments planar range sensors that report an array of range data to software on the visual guidance unit (VGU) may be employed. This allows more flexibility in spacing pallets within a lane, and potential for classifying obstacles (for example, pallet pocket detection) in reverse. In example embodiments obstacle detection may or may not be performed and the VGV drops at a configured distance from the first obstacle detected in a lane. In example embodiments the reverse obstruction sensor is clear while carrying a load so that, for example, trailing plastic wrap does not obstruct the sensor.

### Load Engagement Sensor.

In example embodiments a Boolean sensor may report when a load is fully-engaged against the backrest of the forks. This is useful for picks, since the VGV can simply travel down the lane until a load is detected, at which time it stops and executes the pick.

### Load Disengagement Sensor.

In example embodiments a Boolean sensor may report when a load is fully-disengaged upon completion of a drop. This provides error-detection capabilities to allow the VGV to detect a failed drop. In some embodiments this error detection capability may be implemented using data from a reverse range sensor.

### Pallet Detection System (PDS).

In example embodiments pallet pocket detection system sensor provides the location and orientation of the nearest face of a pallet with fork pockets.

In some example embodiments lanes may have been built with especially inaccurate pallet placement and/or a VGV is unable to follow reverse paths accurately enough to spear pallets without sensing the pallet locations and adjusting its path accordingly. In such cases additional sensing and motion abilities may be employed in accordance with principles of inventive concepts.

That is, the on-robot sensor would naturally detect the pallet relative to itself or the robot's coordinate frame. In example embodiments this location may be transformed to the path coordinate frame in order to alter the path geometry. This requires a transformation relative to the robot's pose estimate, which must be interpolated if the VGV is moving during estimation. An external sensor would be calibrated to determine a transformation between its coordinate system and that of the lane. In example embodiments, one external sensor may cover many lanes, so it may be calibrated with respect to all of them, thus providing a global (or at least regional) coordinate system across many path segments.

Path geometry may be generated to diverge from the trained path, reach the pallet at the detected location and orientation, and return to the trained path again. The generated path segment may be constrained to avoid impinging on any neighboring lanes. The segment may be spliced into existing path geometry with any trained behaviors (e.g. intersection zones) remaining at reasonable locations.

In example embodiments localizations may be disabled during follows. In the case of the PDS, the desired pick location will be detected relative to the VGV. Any corrections from the perception system would be irrelevant to this relative transform, and incorporating them would only decrease the accuracy of the servo to the pallet.

In example embodiments a VGV may steer in place, that is, change its tiller position while stopped, to change the trajectory of the VGV's forks, as the pallet may only be detected at a relatively limited distance (for example, roughly one meter). Allowing steering in place permits the VGV to make path adjustments in close range.

In example embodiments, for VGVs with side-shift capabilities, a VGV may employ lateral motion of the forks to spear an offset pallet.

Referring now to FIG. 10, example embodiments of the process of training and building routes within an intersection including lane zones and grid zones in accordance with principles of inventive concepts will be described. According to the inventive concepts, generating route segments and building a route can comprise:

If Segment Splicing is available, it is used with each Lane Segment to find the point where that segment joins the corresponding Grid Zone on the travel-aisle segment. Otherwise, the end of the Lane Segment is used. A station will be generated at that location (with a name inaccessible to users) for planning purposes. The travel-aisle segment will be split into sub-segments at these stations to allow for interleaved actions on routes that visit multiple lanes.

Segment Reversal will be used to generate reverse-motion segments from each auto-generated station back into the appropriate lane.

Intersections will be generated for each Grid and Lane Zone.

### Training.

In example embodiments, in a system employing segment splicing, as previously described, training may be executed as follows:
1) Train TAE1 to TAE2 with “primary”/“near” Grid Zone GZN.
2) Train TAW1 to TAW2 with “secondary”/“far” Grid Zone GZF, adjacent to GZN.

Train Lane Segments from each of L1, L2, and L3 to TAE2. Each segment should begin with a Lane Zone associated with Grid Zone GZN.

Train Lane Segments from each of L1, L2, and L3 to TAW2. Each segment should begin with a Lane Zone (sharing the names from the previous step), but associated with Grid Zone GZF.

In example, in a system that does not employ segment splicing, the training order of lanes and aisle may be reversed to allow the operator to manually place merge stations:
1) Train Lane Segments from each of L1, L2, and L3 to their associated merge points along TAE1->TAE2. Each segment should begin with a Lane Zone associated with Grid Zone GZN.
2) Train Lane Segments from each of L1, L2, and L3 to their associated merge points along TAW1->TAW2. Each segment should begin with a Lane Zone (sharing the names from the previous step), but associated with Grid Zone GZF.
3) Train TAE1->TAE2 with “primary” Grid Zone GZN. Each merge point must be trained within the zone.
4) Train TAW1->TAW2 with “secondary” Grid Zone GZF, adjacent to GZN. Each merge point must be trained within the zone.

### Building.

In example embodiments, if Segment Splicing is employed, it is used with each Lane Segment to find the point where that segment joins the corresponding Grid Zone on the travel-aisle segment. Otherwise, the end of the Lane Segment is used. The system may generate a station at that location (with a name that may be inaccessible to operators) for planning purposes and the travel-aisle segment may be split into sub-segments at these stations to allow for interleaved actions on routes that visit multiple lanes.

Segment Reversal will be used to generate reverse-motion segments from each auto-generated station back into the appropriate lane.

Intersections will be generated for each Grid and Lane Zone.

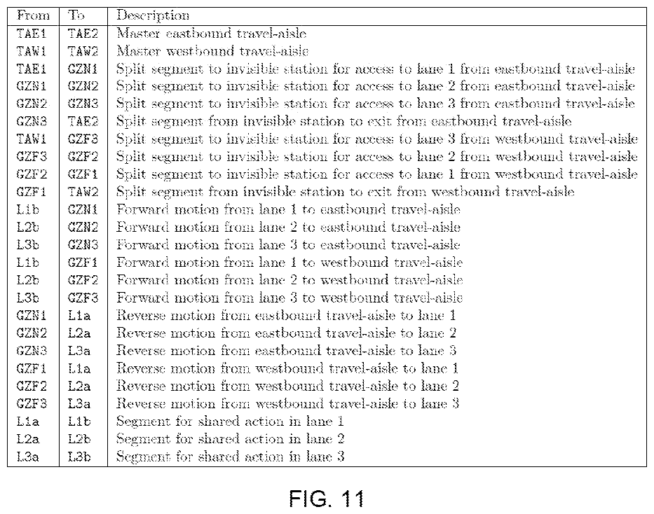

In example embodiments the route network of FIG. 10 may be produced, containing the segments listed in the FIG. 11. In this example, all of the stations except for TAW1, TAW2, TAE1, and TAE2 are Invisible Stations. L1, L2, and L3 are associated with Lane Zones, which may be named as actions (for example, pick or drop) when specifying a route to follow. Two invisible stations (designated a and b) are generated at the same position at the back of each lane where training began. This ensures that any planned route that visits the lane passes through the small loop segment containing the one and only action location in the lane.

### Follow.

In example embodiments path planning may employ Invisible Stations as nodes in the route network. For each lane that must be visited fourInvisible Stations will be visited: the station splicing the Grid Zone to the reversed lane segment, the cusp of the Lane Zone, and the station splicing the (forward) lane segment into the next Grid Zone.

In example embodiments a planned route may be viewed as a timeline labeled with the stations visited. Beneath the timeline, shaded boxes illustrate the duration for which intersection grants are held.

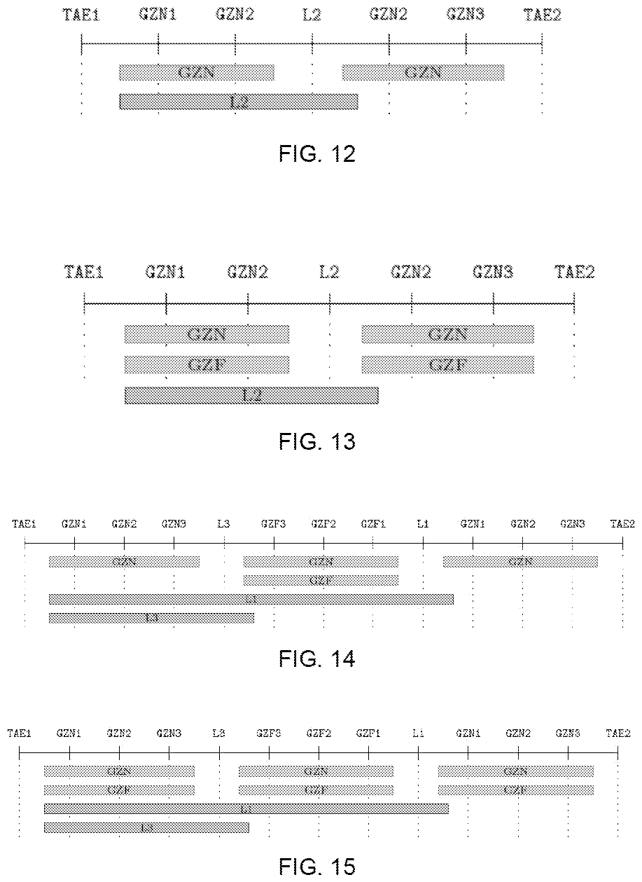

For example, to travel from the west, drop in L2, and exit to the east, in example embodiments the operator would specify “TAE1->DROP: L2->TAE2”, and the planned route would ideally be as illustrated in FIG. 12.

This sequence of intersections assumes that the “near” and “far” aisles are far enough apart and/or the VGV is maneuverable enough to avoid swinging into the “far” aisle when moving between the “near” aisle and the lane. In some embodiments a VGV may be too large for this and, in such embodiments, the “far” aisle may be locked when moving in or out of a lane to the “near” aisle. This leads to the timeline illustrated in FIG. 13 in such cases.

If this vehicle needed to perform Interleaved Lane Actions such as a drop in L3 followed by a pick in L1, the user would specify “TAE1->DROP: L3->PICK: L1->TAE2”. The planned route (with the originally-intended maneuverable VGV) would be as illustrated in FIG. 14.

With the longer-wheelbase VGV, the following timeline is illustrated in FIG. 15. In example embodiments the point at which a lane segment meets a travel-aisle segment may be the same for transitioning from an aisle to a lane as from a lane to an aisle, this allows Segment Reversal. Additionally, the VGV is able to turn out of (and into) the far travel-aisle segment without becoming obstructed on objects beside this segment (that is, on the far side of the aisle) and VGVs operating in adjacent lanes will not obstruct one another. In some embodiments, groups of lanes may be small or clustered together to allow a single intersection to efficiently cover an entire Grid Zone and there is sufficient space between the nearest travel-aisle segment and the beginning of a lane to permit the vehicle to turn sufficiently to reliably engage with a pallet at the earliest position.

Conventionally, in actual deployments, one of the primary reasons that forward and reverse paths are different is that training in reverse is so much more difficult. Although the vehicle kinematics are identical in forward and reverse travel, the control is unstable in the reverse direction. As a result, trainers often try to begin the change of vehicle orientation for entering a lane while traveling forward, and complete it in reverse. When exiting a lane, the entire change of orientation is accomplished in a single, sweeping turn. Using Segment Reversal in accordance with principles of inventive concepts allows operators/trainers to avoid the difficulties of training in reverse travel.

### Narrow Sensing.

In example embodiments a VGV's obstruction sensor fields may be narrow enough to avoid spurious detection of obstacles outside the path of travel, or there may be sufficient free space surrounding the paths. When turning into or out of a segment parallel to staged materials, a VGV's obstruction sensors may be configured so as not to cause the nearby obstacles to be interpreted as obstructions. Alternately, these obstacles may be stored far enough away to avoid spurious obstructions. When operating in a lane, obstruction sensors may be configured so as not to interpret as obstructions materials or vehicles in adjacent lanes. In example embodiments, the obstruction sensors' fields may be small enough to avoid detecting these potential obstacles, and/or the lanes may be sufficiently spaced apart. Additionally, in some embodiments the system may avoid dispatching VGVs to adjacent lanes simultaneously.

Aspects of inventive concepts disclosed herein may be applicable to general mobile robotics, especially involving training by non-expert users, as well as navigation/route-planning using a graph.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can be combined in any given way.

1. A mobile robot, comprising:
a navigation system in operative communication with a drive system;
one or more sensors configured to collect sensor data, wherein the one or more sensors are configured to collect training data representative of a route or portions of a route as the mobile robot is navigated along the route;
a user interface configured to receive user inputs providing route information; and
a route generator configured to process the route information and the training data to generate a route network comprising a plurality of route segments.

2. The system of claim 1, wherein the training data is generated while the mobile robot is navigated in a first direction and the mobile robot is configured to autonomously navigate in a second direction that is opposite the first direction.

3. The system of claim 1, wherein the route generator and user interface are configured to cooperatively generate a display of one or more of the route segments.

4. The system of claim 1, wherein the route information includes unnamed nodes used for connecting route segments while generating the route network.

5. The system of claim 1, wherein the route information includes one or more destinations at which the mobile robot is to perform at least one task.

6. The system of claim 4, wherein the at least one task includes a load pick up and/or a load drop off.

7. The system of claim 1, wherein the route generator is configured to generate a lane zone for one or more lanes identified in the route information.

8. The system of claim 1, wherein the route generator is configured to generate a grid zone for one or more intersections identified in the route information, wherein a grid zone does not include a lane or a lane zone.

9. A route generation method for a mobile robot, comprising:
using one or more sensors to collect training data representative of a route or portions of a route as the mobile robot is navigated along the route;
providing a user interface to receive user inputs providing route information; and
processing the route information and the training data to generate a route network comprising a plurality of route segments.

10. The method of claim 9, further comprising generating the training data while the mobile robot is navigated in a first direction and the mobile robot is configured to autonomously navigate in a second direction that is opposite the first direction.

11. The method of claim 9, further comprising generating a display for presentation via the user interface device of one or more of the route segments.

12. The method of claim 9, wherein the route information includes unnamed nodes used for connecting route segments as part of generating the route network.

13. The method of claim 1, wherein the route information includes one or more destinations at which the mobile robot is to perform at least one task.

14. The method of claim 13, wherein the at least one task includes a load pick up and/or a load drop off.

15. The method of claim 1, further comprising generating a lane zone for one or more lanes identified in the route information.

16. The method of claim 1, further comprising generating a grid zone for one or more intersections identified in the route information, wherein a grid zone does not include a lane or a lane zone.

17. The method of claim 9, further comprising the automatic placement of behaviors.

18. The method of claim 17, wherein the automatic placement of behaviors comprises the placement of intersection entrances.

19. The method of claim 17, wherein the automatic placement of behaviors comprises the placement of intersection exits.

20. The method of claim 9, further comprising providing a user interface to receive user inputs providing behavior information.
